(19) United States
(12) Patent Application Publication
(10) Pub. No.: US 2008/0067244 A1
(43) Pub. Date: Mar. 20, 2008

(54) System and method for counting and tracking individuals, animals and objects in defined locations

(76) Inventor: Jeffrey Marks, Newport Coast, CA (US)

Correspondence Address: Jeffrey S. Marks, 9 Chatelaine, Newport Coast, CA, 92657, US

(21) Appl. No.: 11/902,100

(22) Filed: Sep. 19, 2007

Related U.S. Application Data
(60) Provisional application No. 60/845,750, filed on Sep. 20, 2006.

(51) Int. Cl. G01V 8/20

(52) U.S. Cl. 235/385

(57) ABSTRACT

An automated counting and tracking system for counting the number of individuals, objects or animals having certain common demographics or attributes, located within a defined physical location, which includes a means of determining the composition of persons, items or animals located in such physical location. A method for counting and tracking the number of individuals, objects or animals having certain common demographics or attributes, located within a defined physical location, which includes a method of determining the composition of persons, items or animals located in such physical location.

### RELATED APPLICATIONS

This application claims the benefit of U.S. Provisional Patent Application Nos. 60/842,027, filed Sep. 5, 2006, and 60/845,750, filed Sep. 20, 2006, the disclosures of which are hereby incorporated by reference.

### BACKGROUND

1. Technical Field

The present invention is generally directed to counting, and in particular, to the counting of subsets of individuals, animals or objects within physical spaces, e.g., customers within a night club, bar, restaurant, concert or sporting event.

2. Description of Related Art

Systems and methods for counting people provide valuable statistical information for a wide range of applications. For example, one application is the need to determine the total number of customers passing through an entrance into a commercial establishment. Systems adapted for such applications are described in U.S. Pat. Nos. 3,727,034, 4,303,851, 5,187,688, 6,563,423, 6,712,269 B1. None of these systems provide for tagging and detecting individual persons or groups of persons. These applications are useful to obtain pure statistical information of the number of passersby, however, do not provide a system to monitor any specific attributes of the passersby. In other words, these systems provide for the raw counting of the number of individuals irrespective of their characteristics (i.e., male, female, age).

Several patents have disclosed methods for monitoring and tracking individual customers. U.S. Pat. No. 7,076,441 B2, of Hind et al., discloses a method and system for identifying and tracking persons using RFID-tagged items carried on the persons which can be used to provide targeted advertising and to improve existing store systems and tracking systems. Previous purchase records for each person who shops at a retail store are collected by POS terminals and stored in a transaction database. When a person carrying or wearing items, to which RFID tags are affixed, enters the store or other designated area, a RFID tag scanner located therein scans the RFID tags on that person and reads the RFID tag information. The RFID tag information collected from the person is correlated with transaction records stored in the transaction database according to known correlation algorithms. Based on the results of the correlation, the exact identity of the person or certain characteristics about the person can be determined. This information is used to monitor the movement of the person through the store or other areas. This and other inventions are directed at manufacturers, retails and distributors.

U.S. Pat. No. 6,563,423 B2, of Smith, discloses a device which includes tagging individual customers with a unique electronically readable magnetic tag, coupled with a system that tracks the movements and location of individual customers. The location of each electronically-tagged customer is tracked using proximity sensors at various locations in the establishment, each of which is configured to detect the unique electronically-readable code of a customer located proximate thereto. The system, however, does not provide for counting the number of persons within a defined location at one time. In addition, it discloses a very complex tracking apparatus which includes sensors which must be configured to detect a unique electronically readable code assigned to each and every customer. It also discloses a complex data base for storing such information, and determining what tailored advertising or content to direct to each individual.

No system currently exists that provides a simple method for counting the number and specific characteristics of persons within defined physical areas.

### SUMMARY

A system is disclosed that provides a simple, automated counting and tracking system for individuals that is capable of being used in a number of environments such as bars, nightclubs and concerts, to count the number of customers having certain common demographics or attributes, located within an establishment and/or within a specific physical location or “zone” within an establishment. Such system also provides a means of determining statistical data as further described below. The system may utilize electronically-readable tags worn or carried by, or stamped on, a person that incorporates some magnetic or other coded material, or which emits a radio frequency or other signal, or has some other electronic signature. The tags are assigned one of two, three or more codes, or frequencies, and all individuals that share certain demographics or characteristics (i.e., gender or age) are provided with a tag containing the same code or frequency. Through the sensing of the tags at the entrances and exits within an establishment and/or within a specific physical location, room or zone within an establishment, the number of individuals sharing one or more specific characteristics within such specific physical locations at any one time, can be automatically monitored and determined in a reliable, unobtrusive and cost effective manner.

The utility of providing for a simple counting method is demonstrated by the preferred embodiment described below. At nightclubs, restaurants, sports arenas, concert arenas, and other such venues, there is often a need to track the number of persons located within a specific physical location to determine whether additional patrons should be admitted. There is often also a need to determine the traffic flow of customers and the amounts of time spent in particular zones within the establishment. Prior art discloses various methods for doing so. There, however, is also often a need to maintain a certain male to female ratio, or other ratios based on demographics or characteristics shared by individuals (i.e., age, gender or time of arrival). There is also often a need to obtain simple and easily readable real time, or near real time, data regarding the number and ratio of individuals in an establishment and/or in one or more physically defined locations, rooms or zones within the establishment. Making it more difficult to track this data is that individuals often enter, exit and then reenter these types of establishments multiple times, or continually move to different locations within the establishment, making it difficult for employees to maintain a physical count of and to track the number and type of individuals in the crowd. It is common in these types of venues to tag individuals with a plastic wrist band, or to apply an ink hand stamp to each patron to signify they have been admitted into the establishment and/or into certain defined areas or rooms within the establishment, so they can freely exit and reenter the establishment or such defined areas or rooms, and move about freely therein. The present system provides a simple method of incorporating an electronic tag into the wrist bands, hand stamps or other devices or apparatuses worn or carried by, or affixed to, the customers, which counts the number of customers in total, as well as the number of customers that share certain demographics or characteristics, and the ratios thereof, as they enter and exit the establishment and/or defined physical areas or rooms within the establishment, so management can determine, at any time, the number of patrons and the make up of the crowd. As an example, where concerned about the sheer number of patrons, regardless of their demographics or other characteristics, each customer may be tagged with the same code or signal, or with no code or signal. In the alternative, where concerned with maintaining specific ratios of persons having the same characteristic (i.e., gender, age, or time of admittance), two or more different tags may be used, without the need for collecting, storing and processing unique data from each individual customer, or creating and applying a unique tag to each and every individual. For example, all women entering a nightclub may be provided with a red wrist band, all of which have an embedded electronic sensor bearing the same code or electronic signature, and all males may be provided with a blue wrist band, all of which have an embedded sensor bearing the same code or electronic signature, but which is different from the code contained in the female wrist bands. Such electronic tag or signature may also be an existing signal or code incorporated into a mobile telephone or other hand held device.

Therefore, consistent with one aspect of the invention, an electronic tagging system applies an electronically-readable tag to individuals by incorporating the tag into a wrist band worn by the individual, a stamp applied to an individual's hand or some other device worn or carried by the individual. A signal or frequency emitted by the tag is detected by sensors located throughout the establishment.

Consistent with another aspect of the invention is a method of output for displaying on a computer, a hand held device or other device, certain data collected by the sensing modules, and which may be synthesized with existing records.

Consistent with another aspect of the invention, a simple and unique counting and tracking system is provided for determining one or a plurality of electronically-readable codes or frequencies from an electronic tag incorporated into a wrist band worn by an individual, a hand stamp or other device worn or carried by an individual, and for generating, on the fly, real time, or near real time, data about the number and composition of persons located in a nightclub or other such establishment and/or within one or more defined physical areas or rooms within such establishment.

Consistent with still another aspect of the invention, a system is provided for counting the number and determining the composition of individuals in an establishment and/or within one or more defined physical areas or rooms within such establishment. A plurality of individuals are tagged when they enter the establishment, and each is provided with a wrist band, hand stamp or other apparatus, which incorporates one, two or more electronically-readable codes. The number and composition of persons located in an establishment and/or within one or more defined physical areas or rooms within such establishment, is then tracked using a plurality of sensors disposed at the entrances and exits of the establishment and/or at the entrances and exits of one or more physical areas, rooms or zones in the establishment, such sensors being configured to determine whether each individual is entering or exiting the establishment or defined physical location, and, at the same time, to detect the electronically-readable code of each customer passing such sensor to determine the designated demographic or shared characteristic of each individual. The types of signals emitted from the tags and the sensors may vary widely, but may include, for example, any one or more of the following: (1) a VLF (Very Low Frequency) signal detector system, (2) a magnetic field sensor capable of detecting encoded magnetic markers stamped on the hands of individuals.

In another embodiment of the invention, the electronically readable tags on the individuals are unique to each and every individual, and can be sensed or scanned by one or a plurality of sensing modules such that certain customer information (i.e., prior purchase records) and purchase preference information stored on the electronically readable tags can be determined. This method employs a two-way communication between the tags and the sensors. Such previously stored information may be gathered through previous purchase or other records or data related to such person that have previously been collected by POS terminals or other means and have been stored in a database. When a person carrying or wearing the electronically readable tags enters the establishment or other designated area, a tag detection sensor located therein scans the electronically readable tags on that person and reads the information stored thereon. The tag information collected from the person is correlated with transaction or other records or data stored in the database to determine the exact identity of the person, or some characteristic about the person. Then, as that person moves around the establishment, different tag sensors located throughout the store can pick up the signals or otherwise read the electronic codes imbedded on the tag carried on that person and the movement, activities and/or behavior of that person is tracked based on these detections or scans. The tracking information can be used for a number of purposes. For example, the data could be used to provide targeted advertising or marketing material to the person as the person roams through the establishment, or to analyze and improve existing systems, such as the physical layout of the establishment, advertisement and marketing displays in the establishment, customer service systems in the establishment, lighting and other environmental settings in the establishment. This system could also be used to track and store customer activity within an establishment, such as liquor consumption, food consumption or otherwise, and to create an electronic record which can be used in connection with a customer loyalty program or for other purposes.

In another embodiment of the invention, the electronically readable tags on the individuals contain certain billing or credit information previously provided by the individual to the establishment, or accessible by the establishment, and embedded within the electronically readable tag, can be detected and used by the individual and the establishment as a means of electronic payment.

In yet another embodiment of the invention, after a certain number or kind of purchases by an individual, or aggregate dollar amount of purchases, or number of visits to the establishment, or otherwise, automatic notifications are sent to a computer display or handheld device notifying employees of the establishment of the same, or automatically, notifying employees of the establishment that the customer has earned some reward (i.e., a free drink), or to notify the establishment of the characteristics and purchasing habits of the individual or that certain milestones have been set so the employees of such establishment can provide applicable treatment or individualized treatment to such customers.

Consistent with another embodiment of the invention, the device has a database that stores current data at certain time intervals, so historical data can be analyzed to understand such things as how the ratios and numbers vary over time, or at specific times during a day.

It should be recognized that this invention can be used for purposes other than monitoring and tracking individuals. The invention would be useful in any circumstance where there may exist the need or desire to track individuals, items, animals or objects within a defined location (which may be indoor or outdoor), and to determine the relative ratios of such individuals, items, animals or objects sharing particular characteristics.

For example, the device could be used to track the movement of animals and study their behavior within a particular environment, and/or to study the effects of introducing new elements to such environment. As one example, animals could be tagged to determine the ratios of males to females in a particular location within an environment, and the effect on the relative ratios that may result from changing conditions, such as the time of day, the weather, the time of year, the introduction of more animals of the same sex, the introduction of more animals of the opposite sex, or the introduction of other types of animals.

In addition, depending on the use of the invention, sensing modules could be located at very close distances within an area or at very far distances. For example, in the case of animal studies in large geographic areas, the sensing modules could be located miles a part. In the case of studying small animals in a small location, sensing modules could be located within inches of each other. In one embodiment, the modules would be designed or contain shields to prevent false signals, and crossed signals, or the system employ some method of distinguishing and separating signals where two sensing modules are located in close proximity to each other. In addition, the system could be made waterproof for use in the ocean or in other bodies of water.

In any of the embodiments discussed above, the sensing modules can be embedded in or affixed to the structure of the establishment, contained within handheld or other portable devices carried or accessible to employees in such establishment, or located elsewhere.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

Each of these aspects of the invention can be used alone or in any combination with one or more other aspects of the invention. Also, while each of the aforementioned aspects of the invention may have separate utility from the other aspects, when combined these aspects of the invention can provide an inexpensive, reliable and unobtrusive manner of counting in real time, or near real time, and at any given moment, the number and demographics of customers located in an establishment and/or in one or more defined physical locations or rooms within an establishment. Moreover, such data can be used for a variety of useful purposes, e.g., to monitor compliance with fire codes, to monitor and maintain specific customer ratios, monitor customer traffic flow, etc.

### BRIEF DESCRIPTION OF DRAWINGS

FIG. 1 is a block diagram of a system for counting and tracking the number of individuals, objects or animals having certain common demographics or attributes, located within a defined physical location, which includes a means of determining the composition of persons, items or animals located in such physical location.

FIG. 2 is a flowchart illustrating the processing steps of a system for counting and tracking the number of individuals, objects or animals having certain common demographics or attributes, located within a defined physical location, which includes a means of determining the composition of persons, items or animals located in such physical location.

FIG. 3 illustrates one embodiment of a central control unit (CCU) that stores and analyzes event data captured via two-way communications between tags and the CCU, via the sensing modules.

FIG. 4 is a depiction of what a user interface may look like for a system for counting and tracking the number of individuals, objects or animals having certain common demographics or attributes, located within several zones in a defined physical location.

### DETAILED DESCRIPTION OF PREFERRED EMBODIMENT

When reading this section I have described one preferred embodiment of the invention, however, one should keep in mind several points. First, the following preferred embodiment is what the inventor believes to be the best mode for practicing the invention at the time this patent was filed. Thus, since one of ordinary skill in the art may recognize from the following preferred embodiment that substantially equivalent structures, acts or methods (i.e., the basic counting apparatus, or tag detection apparatus) may be used or combined to achieve the same results in exactly the same way, or to achieve the same results in a not dissimilar way, the following preferred embodiment should not be interpreted as limiting the invention to that embodiment. For example, one recognizes that there are various methods and apparatuses, electronic and otherwise, for counting the number of persons that cross a particular threshold, such as those disclosed in U.S. Pat. Nos. 3,727,034, 4,303,851, 5,187,688, 6,563,423, 6,712,269 B1, and the system described herein should be construed so as to include any such other method. As another example, there are various methods and apparatuses, electronic and otherwise, for incorporating signals (or encoding devices) with one or more unique readable codes that can be detected and read by external sensors, such as those disclosed in U.S. Pat. Nos. 6,563,423 B2 and 7,076,441 B2, and the system described herein should be construed so as to include any such other method.

Likewise, individual aspects of the invention are provided as examples, and, accordingly, one of ordinary skill in the art may recognize from a following preferred structure or act that a substantially equivalent structure or act may be used to either achieve the same results in substantially the same way, or to achieve the same results in a not dissimilar way. For example, there are a number of ways in which the electronic tagging system can be created. As an example, the component emitting the electronic signal could be embedded in a disposable wrist banded attached to individuals as they enter an establishment, or could be specialized ink within a hand stamp applied to an individual when he enters the establishment. As another example, the electronic tags could incorporate one of two or more magnetic polarities, and where the tag detection sensors are configured to sense the magnetized composition. The electronic tag could include a device for emitting radio or sound waves of specific frequencies, and the tag sensing modules are frequency sensors configured to sense the frequency emitted from the electronic tag. The electronic tag could be a bar code, and the sensing modules, actual scanners which are applied to and read the bar code. There may be a naturally created electronic tag. In other words, the electronic tag could be a natural chemical or pheromone emitted by the individual, which can be detected by the sensor and from which the sensor can detect whether the individual has certain characteristics (i.e., gender). As another example, that the tag detection sensor and modules could be embedded in the structure of the establishment, contained within handheld or other portable devices carried or accessible to employees in such establishment, or otherwise embedded in or affixed to the structure of the establishment or on one or more objects located within the establishment.

The following are some examples of how the system could be deployed to track the ratio of men to women within a nightclub. A nightclub owner could embed electronic sensing modules in the walls at the entrances and exits of the establishment, and at the entrance and exits of certain zones within the establishment. Such zones could include, specific bars within the establishment, a patio, bathrooms, outside waiting areas, etc. . . . The business owner could affix disposable wrist bands to males and females as they enter the club, or stamp the hands of the individuals as they entered the club. These are typical non-invasive methods used by nightclubs to signify whether the patron has paid their admission, or whether they should be granted admission to a VIP section, etc. . . . The wristbands provided to men and women in this case, however, would have different radio waves or signals that could be detected by the sensing modules.

The doormen may have a handheld device that displays, in real time, or near real time, the number of men, the number of women, and the ratio of men to women located within the nightclub. The display could contain numerous other information based on the needs of the nightclub. For example, it could include historical information from a particular date and time (i.e., the last Saturday night), it could include target ratios for males to females, it could display recommendations to change the ratios. If certain pre-determined ratios are achieved, a number of events could be triggered. For example, a notification could be automatically sent to the doormen, which may include instructions to stop allowing men into the club until the ratios fall within certain pre-set parameters. When the pre-set parameters are met, a second notice could be sent to the doormen advising them to begin allowing males into the club again. If there are not enough females within a particular zone within the nightclub, a message could be displayed on a message board in other zones that provides a drink special for women and thereby provide an incentive for them to go to the desired zone. If the nightclub owner owns other nearby establishments, the system could send a message to be displayed on a message board in a nearby club that provides a drink special for the gender which is lacking in the first club, and thereby provide an incentive for such persons to leave one establishment and enter another establishment.

The information sent to the display devices could also be synthesized from current real time, or near real time data, as described above, from historical records related to a particular customer, or to all customers, or a combination thereof.

The business owner can use the data for a number of reasons, including, monitoring compliance with fire and safety codes. The business owner can also analyze the data in real time, or near real time, or after the fact to determine whether to change its marketing tactics to for example, target a specific demographic. If there are several zones within an establishment that are being monitored separately, a notification can be sent to the managers to do something to get one specific gender to leave such zone or enter such zone.

In another embodiment, the electronically readable tags on the individuals are unique to each and every individual, and can be sensed or scanned by one or a plurality of sensing modules such that certain customer information (i.e., prior purchase records) and purchase preference information stored on the electronically readable tags can be determined. This method employs a two-way communication between the tags and the sensors. Such previously stored information may be gathered through previous purchase or other records or data related to such person that have previously been collected by POS terminals or other means and have been stored in a database. When a person carrying or wearing the electronically readable tags enters the establishment or other designated area, a tag detection sensor located therein scans the electronically readable tags on that person and reads the information stored thereon. The tag information collected from the person is correlated with transaction or other records or data stored in the database to determine the exact identity of the person, or some characteristic about the person. Then, as that person moves around the establishment, different tag sensors located throughout the store can pick up the signals or otherwise read the electronic codes imbedded on the tag carried on that person and the movement, activities and/or behavior of that person is tracked based on these detections or scans. The tracking information can be used for a number of purposes. For example, the data could be used to provide targeted advertising or marketing material to the person as the person roams through the establishment, or to analyze and improve existing systems, such as the physical layout of the establishment, advertisement and marketing displays in the establishment, customer service systems in the establishment, lighting and other environmental settings in the establishment. This system could also be used to track and store customer activity within an establishment, such as liquor consumption, food consumption or otherwise, and to create an electronic record which can be used in connection with a customer loyalty program or for other purposes.

Furthermore, it is recognized that as technology develops, a number of additional alternatives to achieve an aspect of the invention may arise. Such advances are hereby incorporated herein, and should be recognized as being functionally equivalent or structurally equivalent to the aspect shown or described herein.

Second, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

### DISCUSSION OF FIGURES

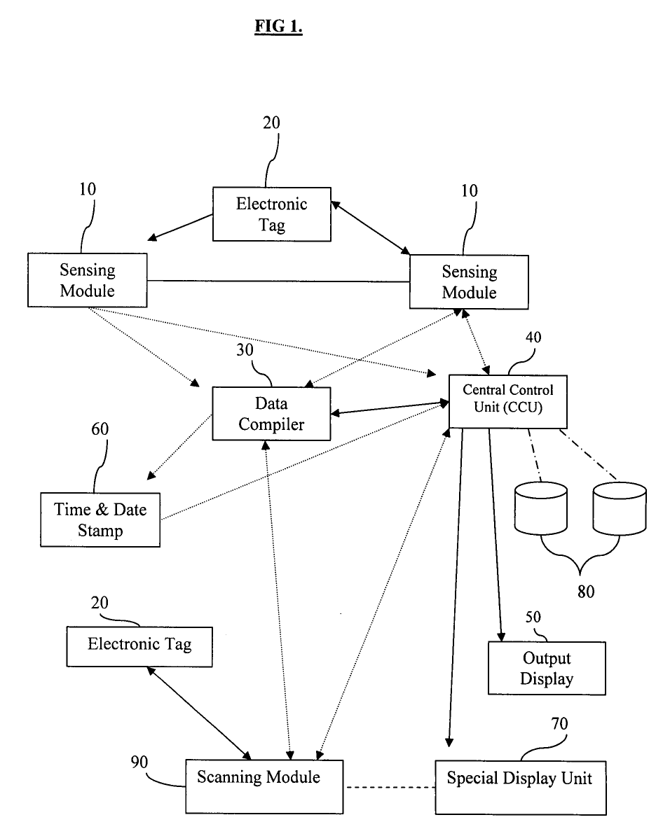

FIG. 1 is a block diagram of a system for counting and tracking the number of individuals, objects or animals having certain common demographics or attributes, located within a defined physical location, which includes a means of determining the composition of persons, items or animals located in such physical location. The system in FIG. 1 will be explained for use of tracking individuals within a bar, but is equally applicable in other locations or geographical areas and to track objects or animals. The system shown in FIG. 1, includes one or more sensing modules 10, each module employing technology or methods which can detect a person crossing a certain threshold, ensure that the same person is not counted twice, detect the direction in which the individual is crossing the threshold, and detect an electronic or other signal emitted from an electronic tag 20 affixed to individuals crossing the threshold.

The types of signals emitted from the tags 20 and detected by the sensors 10 may vary widely, but may include, for example, any one or more of the following: (1) a VLF (Very Low Frequency) signal detector system, (2) a magnetic field sensor capable of detecting encoded magnetic markers stamped on the hands of individuals, and/or (3) a natural biological signal that has a distinct signature based on the shared demographic. In one embodiment, the electronic tag 20 would be included within a disposable wrist band, or washable hand stamp. In one embodiment the signal would be powered by a small battery located within the tag 20. In another embodiment, the signal emitted would be infrared, and in another embodiment the signal would be wireless. In another embodiment, a wireless protocol such as 802.11 may be used.

In another embodiment, the electronically readable tags 20 on the individuals are unique to each and every individual, and can be sensed or scanned by the sensing modules 10 such that certain customer information (i.e., prior purchase records) and purchase preference information stored on the electronically readable tags 20, can be accessed and determined. This method employs a two-way communication between the tags 20 and the CCU 40, through the sensing modules 10. Such previously stored information may be gathered through previous purchase or other records or data related to such person that have previously been collected by POS terminals or other means and have been stored in one or more databases 80 which are coupled to the CCU 40. In one embodiment, such customer information may also be stored in a memory system and mini-computer located in the electronic tag 20 itself. In addition, the system would store new information in the data bases 80 collected through the sensing modules 10. The tag information collected from the person is correlated with transaction or other records or data stored in the database 80 to determine the exact identity of the person, or some characteristic about the person. Then, as that person moves around the establishment, different sensing modules 10 located throughout the establishment can pick up the signals or otherwise read the electronic codes imbedded in the electronic tag 20 carried on that person and the movement, activities and/or behavior of that person is tracked and stored based on these detections or scans. The tracking information can be used for a number of purposes. For example, the data could be used to provide targeted advertising or marketing material to the person as the person roams through the establishment, or to analyze and improve existing systems, such as the physical layout of the establishment, advertisement and marketing displays in the establishment, customer service systems in the establishment, lighting and other environmental settings in the establishment. This system could also be used to track and store customer activity within an establishment, such as liquor consumption, food consumption or otherwise, and to create an electronic record which can be used in connection with a customer loyalty program or for other purposes. Some implementations may incorporate a separate display unit 70, which may be located at certain points within the establishment, and which when reading the electronic signal, it brings up customer loyalty information, or displays marketing messages to the customer. For example, a special display unit 70 may be located at each bar along with a special “extra sensitive” sensing module 10 which requires the tag be held very close to the sensor to detect the signal (and distinguish the signal from the signals emitted from other nearby electronic tags), and which detects the signal on the electronic tag 20, processes the information through the CCU 40 and the data compiler 30 and the databases 80 to identify the customer and send messages to the display that are directed to the customer or the employees of the establishment. For example, targeted marketing messages may be displayed to the customer or a message may be displayed to the bartender which identifies the patron by name, and/or indicates that the customer should be provided with a free drink or a drink special. This mechanism can be used to assist in personalizing the customer experience by allowing the employees of the establishment to identify the customers by name and know their history of patronage.

In some implementations the electronic tag may be embedded in a customer loyalty card or a permanent device kept by the user, or a disposable device, which can pull and integrate customer loyalty and prior customer purchasing information, and be otherwise used in connection with implementing a customer loyalty program.

In another embodiment, an additional mechanism could connect the system (through wired or wireless connection, or otherwise), of one establishment, to the systems of multiple of establishments owned by the same person, or which desire to jointly participate in the use of the system, or a combined customer loyalty program.

The sensing modules are intelligent modules that are connected to and communicate with a common data compiler 30 and the CCU 40, which may be a personal computer or a dedicated processor. In one embodiment the sensing modules would communicate with the CCU via wired connection and in another via wireless connection.

In the embodiment shown in FIG. 1, all of the tags communicate wirelessly with the detection sensors which are connected to a central control unit (CCU) 40 and/or Data Compiler 30. The CCU may be implemented as a personal computer that includes a wireless transceiver card or which is wire-connected to the external sensors. The CCU 40 and the Data Compiler 30 are generally responsible for collecting, storing and analyzing collected data, including location information and demographic make up of the patrons.

In operation, each sensing module 10 detects when a person passes a certain threshold within a defined physical space, and detects an electronic signal emitted from the electronic tag 20 affixed to the individual. In the embodiment shown in FIG. 1, the sensing module 10, serves two functions; it both (1) detects the signal emitted by the tag, and (2) determines whether an individual has crossed a certain threshold. In another embodiment, these two functions may be handled by two separate modules that communicate with each other and/or or with the CCU, which then combines and interprets the information.

Steps are taken by the processor within the sensing module 10 to ensure that the same person is not counted more than once, and the direction in which they are traveling is accurately recorded. The information detected by the sensing modules 10, is communicated to the data compiler 30 and/or the CCU 40, which processes the information and stores the information in the Data Bases 80, along with similar information received from other sensing modules, and in this way dynamically determines for example, the occupancy of different defined physical areas or zones in the same building, and the number of customers that share certain demographics or characteristics, and the ratios thereof, located within such defined physical area as they enter and exit the establishment and/or such defined physical areas or rooms within the establishment. Upon reaching a certain threshold (i.e., number of persons sharing a specified demographic characteristic within a specified area, or number of persons within a specified area) an alert or a notification may be sent to an output display device 50 or some other electronic device. In addition, upon request, specified data (i.e., demographic ratios) may be dynamically computed by the CCU 40 and relayed to the output display device 50.

The CCU 40 and/or Data Compiler 30 may analyze the collected data in real time for purposes of making decisions, such as whether to stop admitting a certain type of patron. The doormen may have a handheld output display device 50 that displays, in real time, the number of men, the number of women, and the ratio of men to women located within the nightclub, which they could check in real time, or near real time. The display could contain numerous other information based on the needs of the nightclub. For example, it could include historical information from a particular date and time (i.e., the last Saturday night), it could include target ratios for males to females, it could display recommendations to change the ratios. If certain pre-determined ratios are achieved, a number of events could be triggered. For example, a notification could be automatically sent to the doormen, which may include instructions to stop allowing men into the club until the ratios fall within certain pre-set parameters. When the pre-set parameters are met, a second notice could be sent to the doormen advising them to begin allowing males into the club again. If there are not enough females within a particular zone within the nightclub, a message could be displayed on a message board in other zones that provides a drink special for women and thereby provide an incentive for them to go to the desired zone. If the nightclub owner owns other nearby establishments, it could send a message displayed on a message board in a nearby club that provides a drink special for the gender which is lacking in the first club, and thereby provide an incentive for such persons to leave one establishment and enter another establishment. As another example, if the CCU 40 detects a rapid increase in the number of patrons within a specific zone, the CCU 40 may alert personnel (e.g., over a nightclub LAN) regarding the possible need to open an additional bar or station, or the need to bring security to decrease the number of individuals within such zone.

The CCU 40 may also run data mining and reporting software that analyzes the data collected over time for purposes of detecting meaningful traffic patterns and trends. For example, the CCU 40 may generate reports showing how customers typically progress through the bar, how much time they spend in each zone, and the demographic make-up of the patrons on particular nights. This information may be used to, for example, adjust the nightclub layout, or to adjust the marketing and promotion of the club to focus on a different demographic.

The CCU 40 may additionally or alternatively convey the data it collects over a cellular network or the Internet to a remote node that handles analysis and reporting tasks. For example, the CCU 40 (and possibly one or more access points) may have an autonomous WAN link that uses a cellular data service such as GPRS to convey the collected data to a remote node for analysis and reporting. This feature can be used to monitor the system from a remote facility, or systems at multiple facilities that are operated in conjunction with each other. The system may also be capable of being tested and configured via the WAN link from the remote facility.

In a preferred embodiment, the CCU 40 processes the information according to certain formulae and algorithms and communicates that information to an output display device 50, which may be a monitor attached to a computer, a handheld device or other display device.

In a preferred embodiment, a time and date stamp and processor module 60 may be coupled with the system such that historical data may be analyzed based on specified dates and times. The time and date stamp and processor module 60, if coupled with the system, may time and date stamp the number and make up of individuals within each defined physical location within the bar, or within the entire bar, at specified intervals (i.e., 10 minute intervals), such that upon request, historical data may be analyzed by the CCU 40 and displayed on the output display device 50, based on specified dates and times.

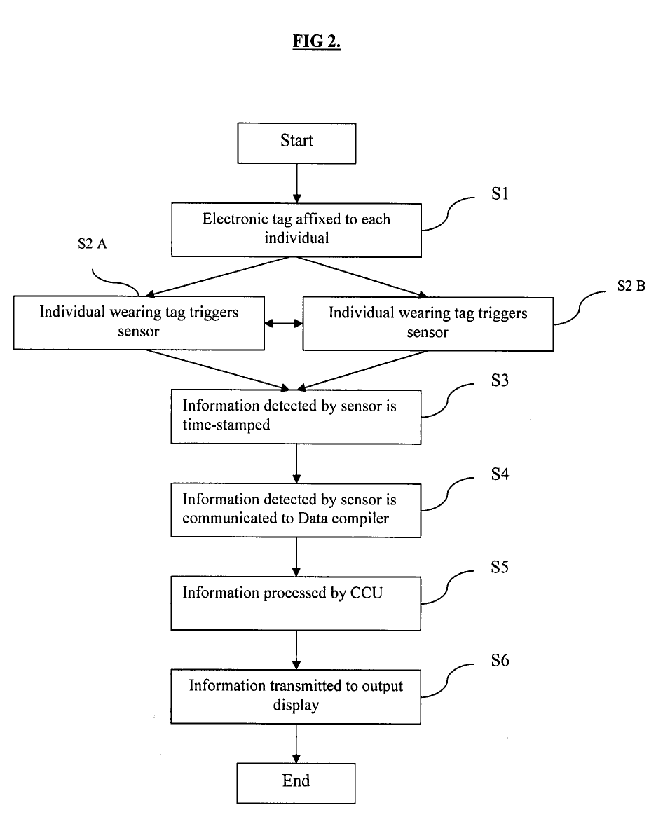

FIG. 2 is a flowchart illustrating the processing steps of the system described in FIG. 1, according to one embodiment of the present invention. These processing steps can be implemented by the system of FIG. 1. As shown in FIG. 2, in Step S1, an electronic tag 20 is provided to an individual. In Step S2A & S2B, when a person carrying an electronic tag 20 passes a certain sensing module 10, the sensing module 10 detects the entrance of the individual in the physical area and reads the electronic signal being emitted from the electronic tag 20. In Step S3, the recorded data is time-stamped. In Step S4, the information detected by the sensor module 10 is communicated to the data compiler 30 which sorts and stores the information in the Databases 80. In Step S5, the information is processed by the CCU 40, and correlated with all of the other information detected by the applicable sensing modules 10. In Step S6, real time, or near real time, data about the number and composition of persons located in the establishment and/or within one or more defined physical areas, rooms or zones within such establishment is sent or otherwise becomes assessable to a display device 50.

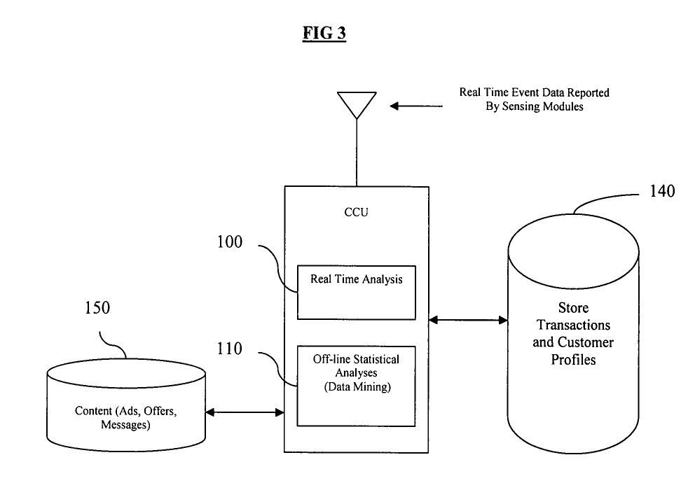

FIG. 3. includes an example embodiment of the some of the components and the analysis logic that would run on the CCU 40 for a system in which each customer is provided with a tag that contains their own unique signal. After a sensing module 10 detects a signal emitted from an electronic tag 20, the CCU 40 preferably accesses a database 140 of purchase transaction data and customer profile data maintained by or obtained from the establishment's central computer to determine whether any existing purchase records or other information exists about such patron, or to otherwise identify such patron. This database 140 preferably contains records of specific purchase transactions of specific customers, historical data regarding their prior visits to the establishments, the amounts spent at and/or the time spent at the establishment. There may also be a stored a customer loyalty number, if one exists.

The analysis components that run on the CCU 40 in the example embodiment of FIG. 3 include a real time analysis component 100 and an off-line statistical analysis component 110. The real time analysis component 100 analyzes event data as it is acquired for purposes of identifying real time actions to take. Examples of such actions include transmitting a particular command to an output display device 50, such as providing specially tailored marketing messages to the customer.

In embodiments which include special display units 70 (for example display units at bars), the real time analysis component 100 may select location-dependent ads or other messages to present to customers or employees of the establishment. For example, upon coming to a bar, the CCU 40 may instruct the special display unit to display a particular ad, promotion, offer, or other message that is specific to that patron. If the customer's loyalty number is known at the time, the ad or message may also be based on the actions taken by this customer in prior visits. For example, if the customer is a regular, a message display may be selected from a content database 150 and wirelessly downloaded to the special display device advising the bartender to provide a free drink to the patron, or notifying the bartender of the name of the patron.

In some implementations, the special display unit 70 may have a scanning module 90, such as a magnetic card reader or a barcode scanner, that enables a customer to swipe a customer loyalty card, another type of card, a magnetic wand or another device, that identifies the customer. In these implementations, the signal emitted may be imbedded in the loyalty card or wand.

The component 110 labeled “off-line statistical analysis” in FIG. 3 is responsible for analyzing the prior store transactions and customer profiles to mine various types of information. One type of information that can be mined is information regarding the effectiveness of the establishment layout. For example, by collectively analyzing transaction records of many different customers, a determination may be made that customers frequently linger in a particular area without purchasing alcohol. The off-line statistical analysis component 110 may also generate data that can be used for targeted or personalized messaging on special display units.

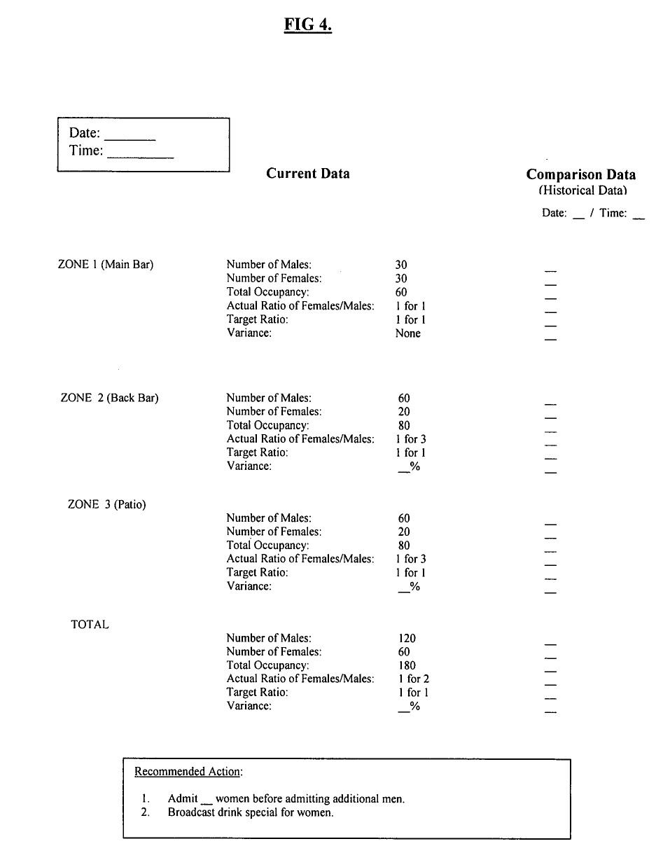

FIG. 4. is a depiction of what a user interface may look like for a system for counting and tracking the number of individuals, objects or animals having certain common demographics or attributes, located within several zones in a defined physical location.

It will be appreciated of course that a number of sensing methods may be used to detect the number of persons traveling across the threshold and the direction in which they are traveling. It will also be appreciated that there may be multiple sensing modules located throughout a physical space and thereby creating zones. The important point is that each module should be able to determine whether a person has crossed a particular threshold, and a unique characteristic about the individual or item passing the threshold.

The processing steps of the present invention can be implemented by computer programs in conjunction with existing hardware, or other devices such as computers, microprocessors, etc. Software programming code which embodies the present invention can be stored in storage of some type. The software programming code may be embodied on any of a variety of known media such as a diskette, or hard drive, or CD-ROM, and may be distributed on such media. The techniques and methods for embodying software program code on physical media and/or distributing software code are known in the art.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

It should also be appreciated that although for purposes of this discussion the counting and sensing of the electronic tags are combined into one module (sensing module 10), there may be separate modules for each of those functions.

The system could have other components included which could serve a number of other functions. For example, a component could keep track of the number or types of drinks ordered by an individual, for customer loyalty program purposes or other purposes. A component could be used to assist individuals in locating other individuals in the club. A component could be added to assist individuals in communicating with other individuals in the club. For example, it could be used to introduce oneself or send messages to another patron within the club, or in another club the system of which is connected to the present system. In one embodiment, such messages may be transmitted wirelessly to handheld display devices held by other patrons, and/or transmitted to computer screens or interfaces that are contained at booths or tables in the establishment.

What is claimed is:

1. A system for counting the number of individuals that have certain shared demographics or characteristics, within a defined physical location, comprising:
(a) one or more sensing modules mounted at the entrance and exit of an establishment, and/or at the entrances and exists of one more defined physical locations, rooms or zones within the establishment, which detects an individual passing through;
(b) one or a plurality of modules (which may be combined with or housed separately from the modules referred to in subsection (a) above), mounted within the configuration of sensing modules described above, comprising: one or more tag detection sensors configured to sense an electronically readable tag or signal, contained within a wrist band worn by an individual, in a stamp applied to an individual, or in some other apparatus carried or worn by the individual, which tag detection sensors are capable of counting the number of individuals in a particular location or zone that share one or more particular demographic characteristic;
(c) one or more sets of electronically readable tags (wrist bands, hand stamps, or other apparatus), each set of which contains a unique electronically readable signature, or emits a frequency, such that the demographic or shared characteristic of each individual carrying or wearing a tag from a particular set can be determined;
(d) a processor coupled to the sensing modules and tag detection sensors which, among other things, is designed to dynamically determine the number of individuals within an establishment and/or one or more physical areas, rooms or zones in the establishment, and to calculate the ratio of customers in the establishment and/or one or more physical areas, rooms or zones, in the establishment, based on one or more specific demographic or other characteristic; and
(e) an electronic means of transmitting and displaying, in substantially real time, the data and information gathered and processed by the central processing means, to a remote computer or handheld or other device.

2. A system as claimed in claim 1, further comprising a database for storing the information detected by the tag detection sensors at specified time intervals, and having a central processing means of calculating, analyzing and displaying the historical numbers and ratios at such time intervals, or trends that occur over any period of time, and to otherwise analyze the data, and which could also employ a time-stamp.

3. The system as in claim 2, further comprising a means for transmitting to and displaying such statistical information on a monitor or handheld device.

4. The system as in claim 3, further comprising a mechanism that transmits and displays on a desktop or handheld device, a warning, notice and/or other applicable information, upon detecting certain statistical information, including, but not limited to, the existence of (a) a specified numbers of total individuals, (b) a specified numbers of individuals sharing a particular demographic or characteristic, or (c) a certain ratio of individuals sharing one or more particular demographics or characteristics, as compared to other individuals sharing one or more different demographics or characteristics.

5. The system as in claim 1, wherein the tag detection sensor comprises at least one shield disposed proximate the tag sensing detector to shield the tag sensing detector from magnetic fields, frequencies or other signals associated with adjacent electronic tags or sensors.

6. The system as in claim 1, wherein the electronically readable tag is or includes an RFID tag, and the sensors incorporate an RFID scanner.

7. The system as in claim 1, where in the electronically readable tags and sensors use blue tooth or similar technology.

8. The system as in claim 1, where in the electronically readable tags are incorporated into an individual's mobile telephone or other hand held device, either by the manufacturer of such device or by some aftermarket method, where such tag could be a SIM card or have some other electronic signature or emit some frequency programmed into the telephone or mobile device, in such a way that such information may be electronically transmitted from the mobile device and scanned and interpreted by the tag detection sensors.

9. The system as in claim 1, further comprising a means where as an individual moves around an establishment, (a) one or more different tag sensors located throughout the venue can pick up radio signals or otherwise read the electronic codes imbedded on, or emitted from, the tag carried on that person so as to track the movement and location of such person; (b) a data base for storing and a central processing means for analyzing the location data for such persons, and/or comparing such location data to the location data of one or more other individual customers.

10. The system as in claim 1, where the tracking information can be used to provide targeted advertising or marketing material to the person as the person roams through the establishment, or to send messages to the employees of the establishment regarding such person, or to analyze and improve existing systems, such as the physical layout of the establishment, advertisement and marketing displays in the establishment, customer service systems in the establishment, lighting and other environmental settings in the establishment.

11. The system as in claim 1, wherein the electronically readable tag has a unique code for each individual.

12. The system as in claim 1, wherein customer information (i.e., prior purchase records, purchasing preferences) is collected and stored (either by the electronic tag itself or by POS terminals), which has been gathered through previous purchase or other records or data related to such person, voluntarily provided by such individual, or other means and have been stored in a database.

13. The system as in claim 1, where when a person carrying or wearing the electronically readable tags enters the establishment or other designated area, a tag detection sensor located therein scans the electronically readable tags on that person and reads the information stored thereon, and the tag information collected from the person is correlated with transaction or other records or data stored in the database to determine the exact identity of the person, or some characteristic about the person.

14. The system as in claim 1, where scanners are used to track and store individual customer activity within the establishment, such as liquor consumption, food consumption or otherwise, and to create an electronic record which can be used in connection with a customer loyalty program or for any other purpose.

15. The system as in claim 1, where after a certain number or kind of purchases by an individual, or aggregate dollar amount of purchases, or number of visits, at or to the establishment (or at or to two or more related establishments participating in the same program), or defined physical location within an establishment or otherwise, automatic notifications are transmitted to a computer display or handheld device notifying the establishment (or establishments) of the same, or automatically, notifying employees of the establishment (or establishments) that the customer has earned a free drink, or to notify the establishment (or establishments) of the characteristics and purchasing habits of the individual or that certain milestones have been met so the employees of such establishment (or establishments) can provide special or individualized treatment to such customers.

16. The system as in claim 1, where the tag detection sensing modules or information scanners, are embedded in handheld or other portable devices carried or accessible to employees in such establishment, or located elsewhere in such establishment, and can access certain billing or credit information previously provided by the individual to the establishment or collected during a prior visit, and stored in a data base linked to the CCU, can be detected or scanned by the detection sensing modules or information scanners, and used by the establishment to charge for purchases made in or at the establishment.

17. The system as in claim 1, where the customer information, preferences, billing or credit information or other data is already encoded into the electronically readable tag, rather than in a data base located in the establishment.

18. The system as in claim 1, where the individual's mobile telephone or other hand held device to which price, targeted messages, or other information is wirelessly transmitted by the establishment through a two-way sensor module or a scanner module, and which is displayed on a screen located on the handheld device.

19. The system as in claim 18, in which the handheld device held by the patron includes certain inputs through which the individual can make wireless payments for purchases, or accept or approve other data, input an amount or other data, and/or transfer that information or other information (either wirelessly or non-wirelessly) to the tag detection sensor or the scanner module.

20. The system of claim 1, which incorporates a special display unit at one or more locations to which the CCU can direct targeted messages to employees or patrons based on signals detected by the sensing modules.

21. The system of claim 1, which incorporates a separate scanner, such as a magnetic card reader or a barcode scanner, that enables a customer to swipe a customer loyalty card, another type of card, a magnetic wand or another device, that identifies the customer.

22. The system as in claim 1, where the detection sensors are configured to sense or read a biological state, a biologically emitted sound wave, feature, chemical or electric biological signal or emission from the individual passerby which is capable of detecting a biological characteristic of such individual through detecting pheromones, chemicals, or other biological signals, functions or emissions from such individual, without such individual making any physical contact with such device, and therefore, able to determine the number of individuals in a particular location, the identity of each individual and/or shared biological characteristics of multiple individuals (i.e., gender, age, medical condition).

23. The system as in claim 1, where the detection sensors can sense or read a biological state, a biologically emitted sound wave, feature, chemical or electric biological signal or emission from the individual passerby which is capable of detecting a biological characteristic of such individual through detecting pheromones, chemicals, or other biological signals, functions or emissions from such individual at such time as such individual makes physical contact with such sensor (whether through physically touching a portion of the device, breathing onto the device, or otherwise).

24. The system as in claim 1, where certain software is downloaded from the internet or beamed to the mobile phone or handheld device held by a patron, which software facilitates some or all of the functions of the system claimed herein.

25. The system as in claim 1, wherein the individual can be identified and/or their purchase records or other data accessed and/or the individual can be tracked, and/or the individual can pay for items, by scanning their finger print at certain points in the establishment or upon the sale of items in the establishment.

26. The system as in claim 1, providing an electronic means for the customer to review and track the information and data gathered and stored, or certain aspects of the information and data that has been gathered and stored, remotely, at any time, through the internet on a secure website sponsored by the establishment.

27. The system as in claim 1, where the customer may make certain reservations at one or more of the establishments and/or pay for certain items, and/or collect certain customer loyalty rewards, remotely, at any time, through the internet on a secure website sponsored by the establishment which integrates with the CCU and the databases.

28. The system as in claim 1, where such system is used in two or more separate locations or by two or more separate establishments, and such systems are linked together and operated by a centrally located CCU and data base which integrates the data received from the sensing modules and scanners at multiple locations, and provides all of the functions described herein, however, on an integrated basis.

29. A method of assigning electronic tags to individuals such that the tag assigned is dependant on one or more characteristics of the individual.

30. The method as in claim 29, where all of the tags that are assigned based on one characteristic emit the same signal, and all of the tags assigned based on a second characteristic emit the same signal, which is different from the signal emitted by the tags assigned based on the first characteristic.

31. The method as in claim 29, wherein based on the signals emitted from the tags, a ratio of individuals having a first characteristic to individuals having a second characteristic, is calculated and displayed, and/or such other statistics and/or information that may be generated from collected data is calculated and displayed.

32. The method as in claim 29, wherein a warning, notice and/or other applicable information is transmitted to and displayed on a desktop or handheld device, upon detecting certain statistical information, including, but not limited to, the existence of (a) a specified numbers of total individuals, (b) a specified numbers of individuals sharing a particular demographic or characteristic, or (c) a certain ratio of individuals sharing one or more particular demographics or characteristics, as compared to other individuals sharing one or more different demographics or characteristics.

33. The method as in claim 29, wherein targeted advertising, marketing or other messages are sent to displays based on information detected by the sensing modules and (a) directed at the patron as the patron roams through the establishment, and/or (b) directed to the employees of the establishment regarding the patron.

34. The method as in claim 29, which includes a method wherein a biological state, a biologically emitted sound wave, feature, chemical or electric biological signal or emission is detected from an individual passerby which is capable of detecting a biological characteristic of such individual through detecting pheromones, chemicals, or other biological signals, functions or emissions from such individual, and therefore, able to determine the number of individuals in a particular location, the identity of each individual and/or shared biological characteristics of multiple individuals (i.e., gender, age, medical condition).
